(19) United States
(12) Patent Application Publication
(10) Pub. No.: US 2007/0034030 A1
(43) Pub. Date: Feb. 15, 2007

(54) Internal combustion engine startup torque transfer mechanism

(75) Inventors: Tomoaki Suzuki, Nagoya-shi (JP); Toshiaki Asada, Mishima-shi (JP); Makoto Ishikawa, Aichi-ken (JP); Toshimitsu Shiba, Toyota-shi (JP); Kazuhito Sakai, Makinohara-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha

(21) Appl. No.: 11/494,609

(22) Filed: Jul. 28, 2006

(30) Foreign Application Priority Data
Jul. 29, 2005 (JP) 2005-220107

(51) Int. Cl. F02N 15/06

(52) U.S. Cl. 74/6

(57) ABSTRACT

A construction width region Aowc of a one-way clutch overlaps with a mesh width region Agg where torque is transferred from a pinion to a ring gear at the time of startup of the engine, so that the center positions of the two regions coincide with each other in the direction of the rotation axis. Due to this overlap, the reaction force that occurs on a one-way clutch when torque is transferred from the pinion to the ring gear can be sufficiently restrained from becoming, together with the torque, a force that inclines the rotation axis of the ring gear. Therefore, it is possible to restrain the direction of engagement force from tilting from a normal position relative to a sprag or the like of the one-way clutch, and to sufficiently prevent occurrence of bad engagement. Furthermore, damages, such as impressions inside a bearing and the like, and deformations of oil seal portions can be prevented.

### INCORPORATION BY REFERENCE

The disclosure of Japanese Patent Applications No. 2005-220107 filed on Jul. 29, 2005, including the specification, drawings and abstract, is incorporated herein by reference in its entirety.

### BACKGROUND OF THE INVENTION

1. Field of the Invention

The invention relates to an internal combustion engine startup torque transfer mechanism that transfers torque in one direction provided by a starter motor to a crankshaft and prevents torque in the reverse direction from being transferred thereto via a pinion, a ring gear and a one-way clutch.

2. Description of the Related Art

Generally in internal combustion engines for vehicles and the like, a ring gear for transferring torque from the starter motor to the crankshaft is formed on an outer peripheral portion of the flywheel. In some of the cases where a torque converter is provided, the ring gear is formed on an outer peripheral portion of a drive plate that is secured to a cover of the torque converter and that transfers the crankshaft torque.

Among such internal combustion engine startup torque transfer mechanisms, there is a known transfer mechanism in which a one-way clutch is interposed between the ring gear and the flywheel in order to allow a constant mesh state of the pinion of the starter motor and the ring gear (e.g., see Japanese Patent Application Publication No. JP-A-2000-274337 (page 3, FIG. 1). Therefore, the torque of the ring gear caused when it is rotated in one direction by the starter motor is transferred to the crankshaft via the one-way clutch and the flywheel. Then, when the crankshaft is rotated by the output of the internal combustion engine, the one-way clutch is released, so that the torque of the crankshaft is not transferred to the ring gear side.

In the case where the drive plate is used, too, a construction in which the drive plate and the ring gear are connected via a one-way clutch is conceivable. This construction also allows a constant mesh state of the pinion and the ring gear as in the case in which the flywheel is used.

However, Japanese Patent Application Publication No. JP-A-2000-274337 mentioned above does not consider the positional relationship between portions that transfer torque therebetween, or a positional relationship of a member that rotatably supports a rotating member. For example, the position of the mesh between the pinion and the ring gear is completely deviated from the one-way clutch in the direction of the rotation axis. This position of the mesh is also deviated from a bearing that rotatably supports the ring gear. Such a deviation operates particularly in the form of a force (torsional moment) that inclines the rotation axis of the ring gear when the starter motor is driven to rotate the crankshaft at the time of starting up the internal combustion engine. The force that inclines the rotation axis of the ring gear also occurs when the crankshaft is rotated in the reverse direction due to the input from the vehicle side.

The inclination of the rotation axis of the ring gear manifests itself as a tilt of a race member of the one-way clutch from the normal position, resulting in reduced engagement force of the one-way clutch. Thus, there is a likelihood of failing to sufficiently raise the rotation speed of the internal combustion engine at the time of startup.

Furthermore, the inclination of the rotation axis of the ring gear becomes a cause of offset loads on the bearing and giving rise to interior impressions formed by the rolling members of the bearing. This will increase the rotation resistance, so that after the internal combustion engine is started, the rolling friction loss becomes great, thus likely leading to degraded fuel economy.

Furthermore, the inclination of the rotation axis of the ring gear affects the gap in an oil seal portion of the internal combustion engine body side so that the oil seal member cannot sufficiently conform to the gap and oil will likely leak.

Thus, the inclination of the rotation axis of the ring gear interferes with various functions in the internal combustion engine startup torque transfer mechanism.

### SUMMARY OF THE INVENTION

In view of the aforementioned problems, there is provided, as an exemplary embodiment of the invention, an internal combustion engine startup torque transfer mechanism capable of preventing the interference with functions by inclination of the rotation axis of the ring gear.

There is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, a construction width region of the one-way clutch overlaps with a mesh width region of the ring gear and the pinion in a direction of a rotation axis.

In the internal combustion engine startup torque transfer mechanism having a structure described above, the construction width region of the one-way clutch overlaps, in the direction of the rotation axis, with the mesh width region where torque is transferred from the pinion to the ring gear. This overlap is a state in which at least portions of the aforementioned regions overlap with each other, and means an overlap state including the case where the whole of one of the regions overlaps with the other region.

Due to this overlap, the reaction force that occurs on a one-way clutch when torque is transferred from the pinion to the ring gear can be restrained from becoming, together with the torque, a force that inclines the rotation axis of the ring gear. Therefore, it is possible to restrain the direction of engagement force from tilting from the normal position in portions that constitute the one-way clutch, and it is possible to sufficiently prevent occurrence of bad engagement of the one-way clutch.

According to another aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and a bearing width region of the bearing overlaps with a mesh width region of the ring gear and the pinion in a direction of a rotation axis.

In the internal combustion engine startup torque transfer mechanism having a structure described above, the bearing width region of the bearing overlaps with the mesh width region in the direction of the rotation axis. This overlap reduces offset loads on the bearing which are associated with the torque that is transferred from the pinion to the ring gear. Therefore, in the inside of the bearing, damages, such as impressions and the like, can be prevented, and increases in friction can be prevented.

According to another aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, a ring-shape seal member is disposed between the ring gear and the crankshaft-side member, and a seal lip of the ring-shape seal member is disposed in a mesh width region of the ring gear and the pinion in a direction of a rotation axis.

Thus, the seal lip of the ring-shape seal member disposed between the ring gear and the crankshaft-side member is located in the mesh width region. The greater the positions of the seal lip deviates from the mesh width region, the greater the change in the seal width relative to the inclination of the rotation axis of the ring gear. Therefore, there is a risk that a portion of the ring-shape seal member may fail to sufficiently follow the change, and that the sealing of the seal lip may become insufficient.

However, since the seal lip of the ring-shape seal member is located in the mesh width region in the invention, sufficient sealing characteristic can be maintained without occurrence of a large change in the seal width even if the rotation axis of the ring gear inclines due to the transfer of torque from the pinion.

According to still another aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, a ring-shape seal member is disposed between the ring gear and a cylinder block-side member, and a seal lip of the ring-shape seal member is disposed in a mesh width region of the ring gear and the pinion in a direction of a rotation axis.

Thus, the ring-shape seal member disposed between the ring gear and the cylinder block-side member is constructed in substantially the same manner as described above. Therefore, since the seal lip is located in the mesh width region, sufficient sealing characteristic can be maintained without occurrence of a large change in the seal width even if the rotation axis of the ring gear inclines due to the transfer of torque from the pinion.

According to yet another aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse)direction from being transferred. In the internal combustion engine startup torque transfer mechanism, ring-shape seal members are disposed respectively between the ring gear and the crankshaft-side member, and between the ring gear and a cylinder block-side member, and a seal lip of the ring-shape seal member is disposed in a mesh width region of the ring gear and the pinion in a direction of a rotation axis.

In the case where the ring-shape seal members are provided respectively between the ring gear and the crankshaft-side member, and between the ring gear and the cylinder block-side member, a construction similar to those described above is provided. In this case, too, the seal lips of the ring-shape seal members are disposed in the mesh width region. Therefore, at any position of sealing, the change in the seal width caused by the inclination of the rotation axis of the ring gear is small as described above, and sufficient sealing characteristic can be maintained.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and a bearing width region of the bearing and a construction width region of the one-way clutch overlap with a mesh width region of the ring gear and the pinion in a direction of a rotation axis.

Thus, the bearing width region of the bearing and the construction width region of the one-way clutch overlap with the mesh width region. Therefore, as for the bearing, offset loads are restrained, and damages thereof, such as interior impressions and the like, can be prevented, as described above. At the same time, as for the one-way clutch, the tilting of the direction of engagement force can be restrained, and bad engagement of the one-way clutch can be prevented.

According to a still further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, a ring-shape seal member is disposed between the ring gear and the crankshaft-side member, and a construction width region of the one-way clutch overlaps with a mesh width region of the ring gear and the pinion in a direction of a rotation axis, and a seal lip of the ring-shape seal member is disposed in the mesh width region in the direction of the rotation axis.

Thus, the construction width region of the one-way clutch overlaps with the mesh width region. Therefore, as for the one-way clutch, the tilting of the direction of engagement force can be restrained, and bad engagement of the one-way clutch can be prevented. At the same time, the seal lip of the ring-shape seal member disposed between the ring gear and the crankshaft-side member is located in the mesh width region. Hence, sufficient sealing characteristic can be maintained without occurrence of a large change in the seal width even if the rotation axis of the ring gear inclines due to the transfer of torque from the pinion, as described above.

According to a yet further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, a ring-shape seal member is disposed between the ring gear and a cylinder block-side member, and wherein a construction width region of the one-way clutch overlaps with a mesh width region of the ring gear and the pinion in a direction of a rotation axis, and a seal lip of the ring-shape seal member is disposed in the mesh width region in the direction of the rotation axis.

Thus, the ring-shape seal member may be provided between the ring gear and the cylinder block-side member. In this case, too, since the seal lip is located in the mesh width region, sufficient sealing characteristic can be maintained without occurrence of a large change in the seal width even if the rotation axis of the ring gear inclines due to the transfer of torque from the pinion, as described above. At the same time, as for the one-way clutch, the tilting of the direction of engagement force can be restrained, and occurrence of bad engagement can be prevented, as described above.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, ring-shape seal members are disposed respectively between the ring gear and the crankshaft-side member, and between the ring gear and a cylinder block-side member, and a construction width region of the one-way clutch overlaps with a mesh width region of the ring gear and the pinion in a direction of a rotation axis, and a seal lip of each ring-shape seal member is disposed in the mesh width region in the direction of the rotation axis.

In the case where two ring-shape seal members are disposed as described above, since the seal lips of the two ring-shape seal members are located in the mesh width region, inclination of the rotation axis of the ring gear will not cause large changes in the seal width at any seal position. Therefore, both seal members can maintain sufficient sealing characteristic. At the same time, as for the one-way clutch, the tilting of the direction of engagement force can be restrained, and occurrence of bad engagement can be prevented, as described above.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and a ring-shape seal member is disposed between the ring gear and the crankshaft-side member, and a bearing width region of the bearing overlaps with a mesh width region of the ring gear and the pinion in a direction of a rotation axis, and a seal lip of the ring-shape seal member is disposed in the mesh width region in the direction of the rotation axis.

Thus, since the bearing width region of the bearing overlaps with the mesh width region, offset loads on the bearing can be restrained, and damages thereof, such as interior impressions and the like, can be prevented, as described above. At the same time, since the seal lip of the ring-shape seal member disposed between the ring gear and the crankshaft-side member is located in the mesh width region, inclination of the rotation axis of the ring gear due to toque transfer from the pinion will not cause a large change in the seal width, as described above. Therefore, sufficient sealing characteristic can be maintained.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and a ring-shape seal member is disposed between the ring gear and a cylinder block-side member, and a bearing width region of the bearing overlaps with a mesh width region of the ring gear and the pinion in a direction of a rotation axis, and a seal lip of the ring-shape seal member is disposed in the mesh width region in the direction of the rotation axis.

Thus, the ring-shape seal member may also be disposed between the ring gear and a cylinder block-side member. Therefore, offset loads on the bearing are restrained, so that damages thereof, such as interior impressions and the like, can be prevented. At the same time, sufficient sealing characteristic can be maintained even if the rotation axis of the ring gear inclines.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and ring-shape seal members are disposed respectively between the ring gear and the crankshaft-side member, and between the ring gear and a cylinder block-side member, and a bearing width region of the bearing overlaps with a mesh width region of the ring gear and the pinion in a direction of a rotation axis, and a seal lip of each ring-shape seal member is disposed in the mesh width region in the direction of the rotation axis.

Thus, ring-shape seal members may be disposed respectively between the ring gear and the crankshaft-side member, and between the ring gear and the cylinder block-side member. Therefore, offset loads on the bearing can be restrained, and damages thereof, such as interior impressions and the like, can be prevented. At the same time, even if the rotation axis of the ring gear inclines, both ring-shape seal members can maintain sufficient sealing characteristic.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and a ring-shape seal member is disposed between the ring gear and the crankshaft-side member, and a bearing width region of the bearing, and a construction width region of the one-way clutch overlap with a mesh width region of the ring gear and the pinion in a direction of a rotation axis, and a seal lip of the ring-shape seal member is disposed in the mesh width region in the direction of the rotation axis.

Thus, the bearing width region of the bearing, and the construction width region of the one-way clutch overlap with the mesh width region where torque is transferred from the pinion to the ring gear, and the seal lip of the ring-shape seal member is disposed in the mesh width region. Therefore, occurrence of bad engagement of the one-way clutch can be prevented, and damages of the bearing, such as interior impressions and the like, can be prevented. At the same time, as for the ring-shape seal member, sufficient sealing characteristic can be maintained.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and a ring-shape seal member is disposed between the ring gear and a cylinder block-side member, and a bearing width region of the bearing, and a construction width region of the one-way clutch overlap with a mesh width region of the ring gear and the pinion in a direction of a rotation axis, and a seal lip of the ring-shape seal member is disposed in the mesh width region in the direction of the rotation axis.

Thus, the ring-shape seal member may be provided between the ring gear and the cylinder block-side member. Therefore, bad engagement of the one-way clutch, and damages of the bearing, such as interior impressions and the like, can be prevented, and at the same time, sufficient sealing characteristic of the ring-shape seal member can be maintained, as described above.

According to a further aspect of the invention, there is provided an internal combustion engine startup torque transfer mechanism including a pinion that is rotated by a starter motor, a ring gear that meshes with the pinion and that transfers a torque of the pinion to a crankshaft of an internal combustion engine, and a one-way clutch that is provided between the ring gear and a crankshaft-side member, and that transfers a torque in one direction provided by the starter motor from the ring gear to the crankshaft, and that prevents a torque in a reverse direction from being transferred. In the internal combustion engine startup torque transfer mechanism, the ring gear is freely rotatably mounted to a crankshaft side via a bearing, and ring-shape seal members are disposed respectively between the ring gear and the crankshaft-side member, and between the ring gear and a cylinder block-side member, and a bearing width region of the bearing, and a construction width region of the one-way clutch overlap with a mesh width region of the ring gear and the pinion in a direction of a rotation axis, and a seat lip of each ring-shape seal member is disposed in the mesh width region in the direction of the rotation axis.

Thus, in the case where two ring-shape seal members are disposed, a construction similar to those described above is provided. Therefore, bad engagement of the one-way clutch, and damages of the bearing, such as interior impressions and the like, can be prevented, and at the same time, sufficient sealing characteristic of the two ring-shape seal members can be maintained, as described above.

In the above-described internal combustion engine startup torque transfer mechanism, it is also preferable that the pinion and the ring gear be of a constant mesh type. Thus, it is possible to adopt a pinion and a ring gear of a constant mesh type, that is, a type in which the meshed state of the pinion and the ring gear is maintained even after the internal combustion engine is started up.

As for the constant mesh type, there is no need for the action of the pinion meshing with the gear portion of the ring gear at the time of startup of the engine. Therefore, the ring gear is not given a force that inclines the rotation axis due to friction during a meshing action. Hence, offset loads on the bearing and the tilting of the direction of engagement force on the one-way clutch can be further effectively restrained, and sealing characteristic of the ring-shape seal members can be even more reliably maintained.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 is a longitudinal sectional view of an internal combustion engine startup torque transfer mechanism of a first embodiment of the invention;

FIG. 2 is a longitudinal sectional view of an internal combustion engine startup torque transfer mechanism of a second embodiment; and

FIG. 3 is a longitudinal sectional view of an internal combustion engine startup torque transfer mechanism of a third embodiment.

### DETAILED DESCRIPTION OF THE PREFERRED EMBODIMENTS

In the following description and the accompanying drawings, the present invention will be described in more detail with reference to exemplary embodiments.

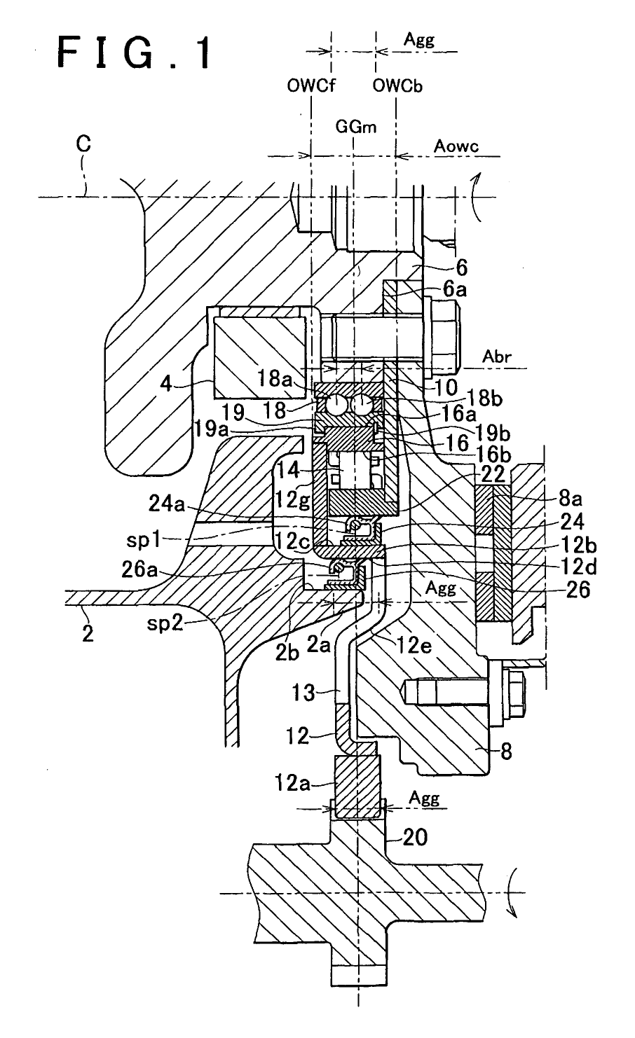

FIG. 1 shows an internal combustion engine startup torque transfer mechanism for a vehicular internal combustion engine in accordance with a first embodiment of the invention, and is a sectional view of a rear side portion of the internal combustion engine related to the output to the side of a transmission.

A rear end of a crankshaft 6 rotatably supported on a cylinder block side by a ladder beam 4 is disposed above a rear end of an oil pan 2. A flywheel 8, an outer race support plate 10 (corresponding to a one-way clutch-purpose race support plate), and a ring gear 12 are mounted to the rear end of the crankshaft 6.

The flywheel 8, whose lower half is shown in FIG. 1, has a generally disc-like shape with a circular opening in a central portion thereof On a side of the flywheel 8 opposite from the side thereof being in contact with the outer race support plate 10, a clutch disc 8a is mounted. The clutch disc 8a constitutes a portion of a clutch mechanism for transferring torque to and from a transmission. The clutch mechanism and the flywheel 8 are formed as separate bodies.

The outer race support plate 10, whose lower half is shown in FIG. 1, is formed so as to have a circular flat plate shape with a central opening. The outer race support plate 10, together with the flywheel 8, is fixed at a central opening peripheral portion thereof to a rear end surface 6a of the crankshaft 6 by bolt fastening. Thus, the outer race support plate 10 is constructed so as to rotate together with the flywheel 8 in an interlock with the crankshaft 6.

The ring gear 12, whose lower half is shown in FIG. 1, is a disc having a large opening in a central portion and having a bent portion (a cylindrical step portion 12b and a curved portion 12e) that is bent in radial directions. The central opening portion of the ring gear 12 is provided with a flange-like inner race 16 of the one-way clutch 14. An outer peripheral portion of the ring gear 12 is provided with a ring-shaped gear portion 12a. The ring gear 12 is mounted to an outer periphery of the crankshaft 6 via a bearing 18 that is provided at a side of the inner race 16 opposite from the one-way clutch 14, that is, at a center-side of the inner race 16 (herein, the bearing 18 is a self-alignment rolling bearing and, in particular, a self-alignment ball bearing). Therefore, when the one-way clutch 14 is in a released state, the ring gear 12 is freely rotatable independently of the rotation of the crankshaft 6.

The bearing 18 is mounted to an outer periphery of the crankshaft 6 by press-fitting. The inner race 16 of the one-way clutch 14 is fitted to an outer race 19 of the bearing 18. Movements of the bearing 18 in the directions of the rotation axis are prevented by two thrust bearing portions 19a, 19b. Of the two thrust bearing portions, a thrust bearing portion 19a is formed integrally with the outer race 19 of the bearing 18. The other thrust bearing portion 19b is a snap ring that is mounted after the inner race 16 of the one-way clutch 14 is mounted. It is permissible that both thrust bearing 19a, 19b be formed by snap rings.

The ring gear 12a of the ring gear 12 is constantly meshed with a pinion 20 of a starter motor. Receiving torque from the starter motor via the pinion 20, the ring gear 12 rotates. In the ring gear 12, a region between the cylindrical step portion 12b and the ring gear 12a has a plurality of hole portions 13 that are formed around a center axis C. This construction reduces the weight of the ring gear 12 and, furthermore, allows the checking of interior states, such as the oil seal state and the like, after the ring gear 12 is disposed by attaching it to a rear portion of the crankshaft 6.

An outer race 22 is mounted to an outer peripheral portion of the outer race support plate 10 so as to face the inner race 16 mounted to the central opening portion of the ring gear 12. Thus, the one-way clutch 14 is constructed between the ring gear 12 and the outer race support plate 10. Therefore, the bearing 18 is disposed on the side of an inner peripheral surface 16a of the inner race 16, and the one-way clutch 14 is constructed on the side of an outer peripheral surface 16b thereof opposite from the inner peripheral surface 16a. Therefore, the one-way clutch 14 is covered in the directions of the rotation axis, by a ring gear base portion 12g that is mounted to the inner race 16, and by the outer race support plate 10 to which the outer race 22 is mounted.

The one-way clutch 14 constructed as described above puts the outer race support plate 10 and the ring gear 12 in an engaged state in the case where rotation is in a direction that allows torque of the starter motor to be transferred from the side of the ring gear 12 to the outer race support plate 10. Therefore, the starter motor can rotate the crankshaft 6.

After the internal combustion engine starts operating, the rotation of the outer race support plate 10 that is driven in the interlock with the crankshaft 6 by the output of the internal combustion engine becomes faster than the rotation of the ring gear 12 caused by the starter motor, so that the rotation of the side of the ring gear 12 is in the reverse direction relative to the outer race support plate 10. Therefore, the one-way clutch 14 becomes released. Thus, even though the pinion 20 and the ring gear 12 are in a constant mesh state, the starter motor can be stopped after the internal combustion engine is started up. Hence, overspeed of the starter motor can be prevented.

In this internal combustion engine, the engine oil is supplied for lubrication of the bearing 18 and the one-way clutch 14, via an oil passageway in the cylinder block or the crankshaft 6. Since the outer race support plate 10 and the ring gear 12 are disposed sandwiching the one-way clutch 14, it is necessary to prevent oil leakage between these members. Therefore, a ring-shaped first oil seal member 24 (corresponding to a ring-shaped seal member) is disposed between the outer race 22 of the one-way clutch 14 and the cylindrical step portion 12b of the ring gear 12. This first oil seal member 24 is fitted to the inner peripheral surface 12c of the cylindrical step portion 12b, and is thus fixed to the side of the ring gear 12. Due to this arrangement, a seal lip 24a formed on an inner peripheral side of the first oil seal member 24 slidably contacts an outer peripheral surface of the outer race 22, thus carrying out oil sealing.

A second oil seal member 26 (corresponding to a ring-shaped seal member) that is larger in diameter than the first oil seal member 24 is disposed on a side (outer side) of cylindrical step portion 12b opposite from the first oil seal member 24. The second oil seal member 26 is fixed in a position as shown in FIG. 1 by fitting it mainly to an inner peripheral surface 2b of a rear end 2a of the oil pan 2 (corresponding to a cylinder block-side member) at a side below the crankshaft 6, and by fitting it mainly to an inner peripheral surface of a rear end of the cylinder block (corresponding to a cylinder block-side member) at a side above the crankshaft 6. Due to this arrangement, a seal lip 26a formed on an inner peripheral surface of the second oil seal member 26 slidably contacts an outer peripheral surface 12d of the cylindrical step portion 12b, thus carrying out oil sealing.

In the internal combustion engine startup torque transfer mechanism described above, the positional relationships in the direction of the rotation axis (direction of the center axis C) among a mesh width region Agg of the pinion 20 and the ring gear 12, the one-way clutch 14, the bearing 18, and two oil seal members 24, 26 are as follows.

A region between an outer surface position OWCf of the ring gear base portion 12g covering the one-way clutch 14 at the forward side in the direction of the rotation axis and an outer surface position OWCb of the outer race support plate 10 covering the one-way clutch 14 at rearward side in the direction of the rotation axis is defined as a construction width region Aowc of the one-way clutch 14. The construction width region Aowc corresponds to a maximum width region between the outer race support plate 10 and the ring gear 12. The aforementioned mesh width region Agg overlaps with the construction width region Aowc of the one-way clutch 14 in the direction of the rotation axis. The “overlap” herein refers to a state where at least portions of two regions overlap with each other. As for the overlap in FIG. 1, the entire region of the mesh width region Agg overlaps with the construction width region Aowc of the one-way clutch 14.

Furthermore, in the overlap state in FIG. 1, a center position GGm of the mesh width region Agg is located within the construction width region Aowc. Moreover, the center position GGm of the mesh width region Agg substantially coincides (perfectly coincides herein) with a center position of the construction width region Aowc.

A bearing width region Abr that is a region between the centers of rows of balls 18a, 18b that constitute the bearing 18 overlaps with the mesh width region Agg. In FIG. 1, the entire region of the bearing width region Abr overlaps with the mesh width region Agg. Furthermore, the center position GGm of the mesh width region Agg is located within the bearing width region Abr.

The seal lips 24a, 26a of the two seal members 24, 26 are located within the mesh width region Agg. Of these, the seal lip 24a of the first oil seal member 24 is at the center position GGm of the mesh width region Agg. Furthermore, the seal lip 24a of the first oil seal member 24 is located within the bearing width region Abr as well.

According to the first embodiment described above, the following effects are obtained.

(i) The mesh width region Agg where torque is transferred from the pinion 20 to ring gear 12 at the time of engine startup overlaps with the construction width region Aowc where an outer shell of the one-way clutch 14 is formed, in the direction of the rotation axis so that the center positions of the two regions coincide. Due to this overlap, the reaction force that occurs on the one-way clutch 14 when torque is transferred from the pinion 20 to the ring gear 12 can be sufficiently restrained from becoming, together with the torque, a force that inclines the rotation axis of the ring gear 12, Therefore, it is possible to restrain the direction of engagement force from tilting from the normal position relative to portions that constitute the one-way clutch 14, in particular, a sprag provided therein, or the like, and therefore it is possible to sufficiently prevent occurrence of bad engagement.

(ii) The mesh width region Agg also overlaps with the bearing width region Abr of the bearing 18. In particular, the center position GGm of the mesh width region Agg is within the bearing width region Abr. This overlap reduces offset loads on the bearing 18 which are associated with the torque that is transferred from the pinion 20 to the ring gear 12. In particular, the bearing 18 is a self-alignment ball bearing, and the bearing width region Abr is set as an interval between the centers of the rows of balls 18a, 18b that are the rolling members. Therefore, the offset in load between the rows of balls 18a, 18b is made sufficiently small. Therefore, in the inside of the bearing 18, damages, such as impressions and the like, can be prevented, and increases in friction can be prevented.

(iii) The seal lips 24a, 26a of the two oil seal members 24, 26 are within the mesh width region Agg. If the positions of the seal lips 24a, 26a deviate from the mesh width region Agg, the change in the seal width relative to the inclination of the rotation axis of the ring gear 12 becomes greater as the positional deviation becomes greater. The seal width herein is a gap between the outer race 22 and the cylindrical step portion 12b with regard to the first oil seal member 24, and is a gap between the cylindrical step portion 12b and the rear end 2a of the oil pan 2 and the cylinder block with regard to the second oil seal member 26.

In the first embodiment, the seal lips 24a, 26a of the oil seal members 24, 26 are located within the mesh width region Agg in the direction of the rotation axis. Therefore, even if the rotation axis of the ring gear 12 inclines due to the torque transfer from the pinion 20, the sealed state can be sufficiently maintained without occurrence of a large change in the seal width.

The second oil seal member 26 carries out the oil sealing by the seal lip 26 sliding against the cylindrical step portion 12b only at the time of startup of the engine. When the pinion 20 stops rotating after the engine has been started up, the sliding between the seal lip 26a and the cylindrical step portion 12b disappears. With regard to the seal lip 24a of the first oil seal member 24, on the other hand, when the engine is being started up, the ring gear 12 and the outer race 22 rotate as a one unit, and therefore there is no sliding with respect to the outer race 22. However, after the engine is started, such sliding exists as long as the crankshaft 6 rotates.

Therefore, in particular, since the sealing characteristic attained by the first oil seal member 24 is important, the seal lip 24a of the first oil seal member 24 is preferentially located so as to coincide with the center position GGm of the mesh width region Agg in the first embodiment. Therefore, the fluctuations in the seal width are particularly made smaller, so that deformation of the first oil seal member 24 will not occur. In this manner, sufficient sealing characteristic can be maintained.

(iv) The internal combustion engine startup torque transfer mechanism of the first embodiment is of a constant mesh type in which the meshed state of the pinion 20 and the ring gear 12 is maintained even after the internal combustion engine is started up. That is, since the pinion 20 does not move in the direction of the rotation axis at the time of the startup, no force caused by friction to act in such a direction as to incline the rotation axis is applied to the ring gear 12a of the ring gear 12. Therefore, offset loads on the bearing 18 and the tilt of the direction of engagement force on the one-way clutch 14 can be more effectively restrained, so that the sealing characteristic of the oil seal members 24, 26 can be even more reliably maintained.

(v) The ring gear 12 is fitted to the thrust bearing portion 19 of the bearing 18, and is stopped from thrusting by the two thrust bearing portions 19a, 19b. These thrust bearing portions 19a, 19b are both provided on the thrust bearing portion 19 of the bearing 18. Therefore, the factors for dimensional variations between the thrust bearing portions 19a, 19b decrease, so that the amount of backlash of the ring gear 12 in the direction of the rotation axis can be reduced.

Therefore, the first oil seal member 24 fitted to the cylindrical step portion 12b of the ring gear 12 is prevented from moving in the direction of the rotation axis, so that the seal lip 24a will not deviate relative to the outer race 22 in the direction of the rotation axis. Hence, even higher sealing characteristic can be maintained.

With respect to the second oil seal member 26, too, the cylindrical step portion 12b of the ring gear 12 that the seal lip 26a contacts does not deviate in the direction of the rotation axis. Hence, even higher sealing characteristic can be maintained.

Since the thrust bearing portions 19a, 19b are members that rotate and stop together with the ring gear 12, the thrust bearing portions 19a, 19b do not assume a sliding state relative to the ring gear 12 during operation of the internal combustion engine. Therefore, increases of friction of the internal combustion engine can be prevented.

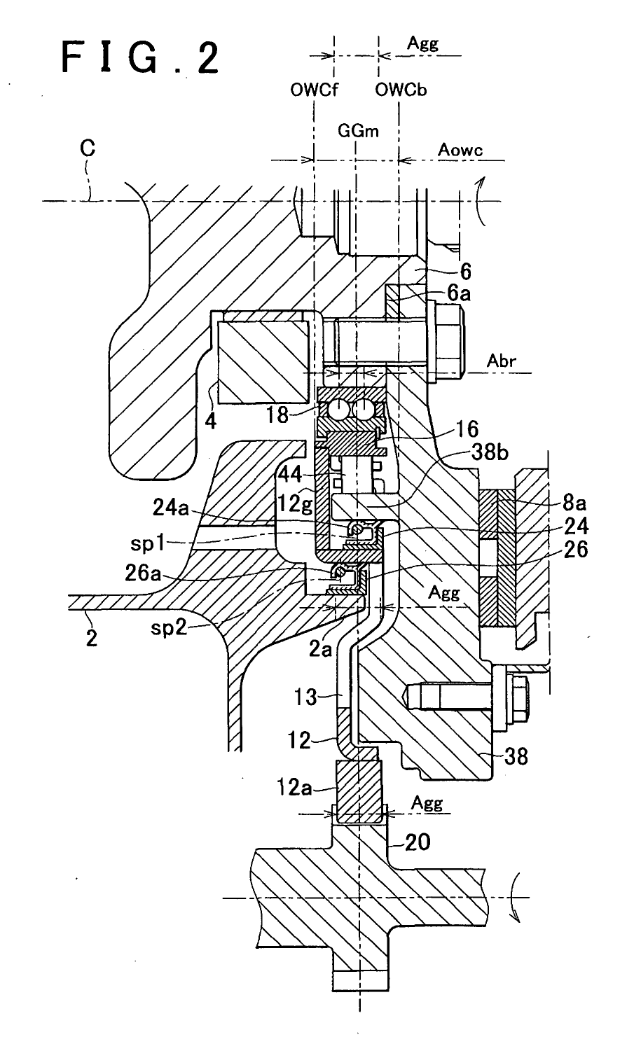

Next, an internal combustion engine startup torque transfer mechanism of a second embodiment will be described. In the second embodiment, as shown in FIG. 2, an outer race support plate 10 shown in FIG. 1 does not exist, and an outer race 38b (corresponding to the race member) for a one-way clutch 44 is protruded from a surface of a flywheel 38 so as to form a ring shape. Other constructions are the same as those in the first embodiment, and are represented by the same reference characters in FIG. 2.

In the construction shown in FIG. 1, since the outer race support plate 10 provided in the foregoing internal combustion engine startup torque transfer mechanism is not provided in this embodiment, a base portion of the outer race 38b for the one-way clutch 44 corresponds to the outer surface position OWCb of the first embodiment. Therefore, the relationships among the one-way clutch 44, the bearing 18 and the oil seal members 24, 26, the mesh width region Agg of the pinion 20 and the ring gear 12 in the direction of the rotation axis (direction of the center axis C) are the same as the positional relationships among the comparable members and the like in the first embodiment.

According to the above-described second embodiment, the following effects are obtained.

(i) Substantially the same effects as in the first embodiment are brought about if the one-way clutch 44 is constructed with the flywheel 38 being used as a crankshaft side member.

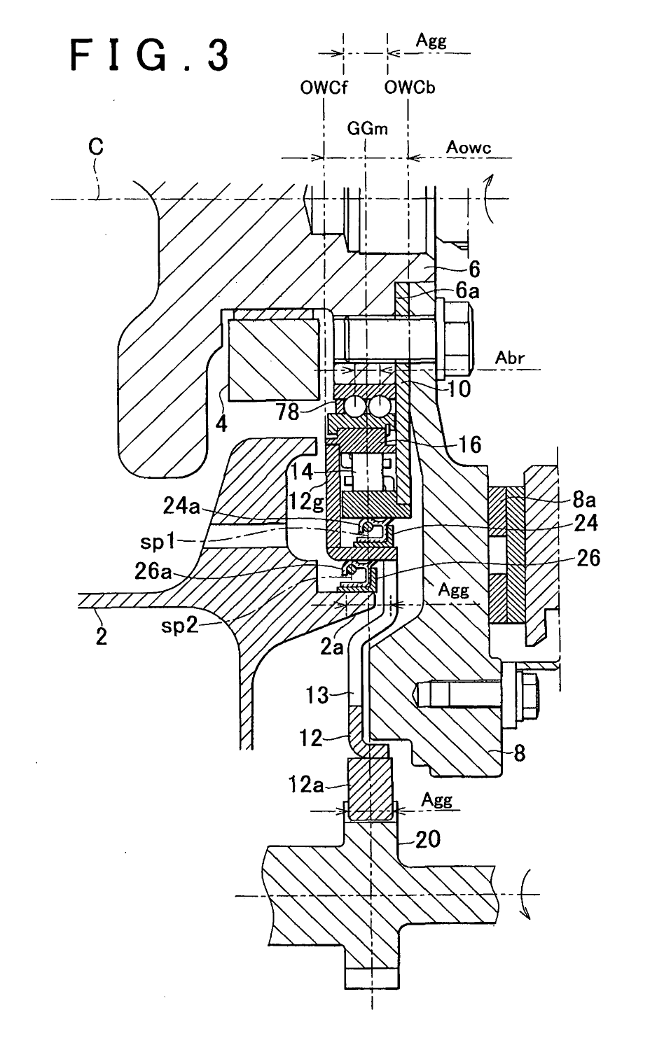

Next, an internal combustion engine startup torque transfer mechanism of a third embodiment will be described. The third embodiment, as shown in FIG. 3, is different from the first embodiment in that the center position GGm of the mesh width region Agg coincides with the center position of the bearing width region Abr of a bearing 78. Other constructions are the same as those of the first embodiment, and are represented by the same reference characters.

According to the third embodiment described above, the following effects are obtained.

(i) In relation to the effects of the first embodiment, offset loads on the bearing 78 can be sufficiently decreased. Therefore, in the inside of the bearing 78, damages, such as impressions and the like, can be more reliably prevented, and increases in friction can be more effectively prevented.

(a) Although in the third embodiment, the outer race support plate is provided, another construction as in the second embodiment is also possible, in which an outer race support plate is not provided, and the flywheel is used as a crankshaft member, and an outer race for the one-way clutch is protruded from the flywheel.

Furthermore, if instead of the flywheel, a drive plate is adopted as in a torque converter, the drive plate may be used as a crank shaft-side member, and the outer race for the one-way clutch may be protruded from the drive plate. In this case, the construction width region of the one-way clutch is a maximum width region between the ring gear and the outer race provided on the drive plate as in the second embodiment. In this construction, too, the effects of the second embodiment are brought about.

(b) In the first to third embodiments, the center position of the construction width region Aowc of the one-way clutch is located at the center position GGm of the mesh width region Agg. In stead of this construction, another construction is possible, in which the center position GGm of the mesh width region Agg is located within the construction width region Aowc of the one-clutch. Still another construction is possible in which a portion of the mesh width region Agg overlaps with the construction width region Aowc of the one-way clutch.

These constructions also make it possible to restrain the action of engagement force on the sprag of the one-way clutch or the like in a direction tilted from the normal position. This will prevent occurrence of bad engagement. Furthermore, the relationship between the mesh width region Agg and the construction width region Aowc independently exerts the effect of restraining the bad engagement of the one-way clutch. That is, even if the relationships of the mesh width region Agg with other constructions (e.g., the seal lip position of each oil seal member, the bearing width region Abr of the bearing, herein) are not the relationships as described in conjunction with the first to third embodiments, the aforementioned effects can be exerted.

(c) In the first to third embodiments, the seal lip of the first seal member is disposed at the center position GGm of the mesh width region Agg. The seal lip of the first oil seal may also be disposed at any appropriate position in the mesh width region Agg, instead of the center position GGm.

This also makes it possible to maintain the sealed state without occurrence of a large change in the seal width, even if the rotation axis of the ring gear inclines due to the torque transfer from the pinion.

In the first to third embodiments, the seal lip of the second oil seal member is within the mesh width region Agg, but not at the center position GGm thereof With this arrangement, the sealed state can be sufficiently maintained without occurrence of a large change in the seal width even if the rotation axis of the ring gear inclines. However, the disposition of the seal lip of the second oil seal member at the center position GGm further enhances the effect of maintaining the sealing characteristic of the second oil seal member.

The relationship of the mesh width region Agg with the seal lip of each oil seal member can independently exert the effect of maintaining sealing characteristic even if the relationships of the mesh width region Agg with other constructions (e.g., the construction width region Aowc of the one-way clutch, or the bearing width region Abr of the bearing, herein) are not the relationships as described above in conjunction with the first to third embodiments.

(d) In the first to third embodiments, the center position GGm of the mesh width region Agg is located so as to be within the bearing width region Abr or coincide with the center position of the bearing width region Abr. Besides, the mesh width region Agg and the bearing width region Abr may be located so as to overlap with each other, irrespective of the center position GGm.

This will also restrain offset loads on the bearing at the time of engine startup. Therefore, in the inside of the bearing, damages, such as impressions and the like, can be prevented, and increases in friction can be prevented. Furthermore, the relationship between the mesh width region Agg and the bearing width region Abr can independently exert the effect of restraining the bearing offset loads. That is, the aforementioned effects can be exerted even if the relationships of the mesh width region Agg with other construction (e.g., the construction width region Aowc of the one-way clutch, the seal lip position of each oil seal member, herein) are not the relationships as described above in conjunction with the first to third embodiments.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein a construction width region of the one-way clutch overlaps with a mesh width region of the ring gear and the pinion in a direction of a rotation axis.

2. The internal combustion engine startup torque transfer mechanism according to claim 1, wherein the crankshaft-side member is a one-way clutch-purpose race support plate provided separately from a flywheel, and wherein the construction width region of the one-way clutch is a maximum width region between the one-way clutch-purpose race support plate and the ring gear.

3. The internal combustion engine startup torque transfer mechanism according to claim 1, wherein the crankshaft-side member is a flywheel, and wherein the construction width region of the one-way clutch is a maximum width region between the ring gear and a race member of the one-way clutch which is provided on the flywheel.

4. The internal combustion engine startup torque transfer mechanism according to claim 1, wherein a center position of the mesh width region of the ring gear and the pinion in the direction of the rotation axis is located in the construction width region of the one-way clutch.

5. The internal combustion engine startup torque transfer mechanism according to claim 1, wherein, in the direction of the rotation axis, a center position of the mesh width region of the ring gear and the pinion substantially coincides with a center position of the construction width region of the one-way clutch.

6. The internal combustion engine startup torque transfer mechanism according to claim 1, wherein the pinion and the ring gear are of a constant mesh type.

7. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein a bearing width region of the bearing overlaps with a mesh width region of the ring gear and the pinion in a direction of a rotation axis.

8. The internal combustion engine startup torque transfer mechanism according to claim 7, wherein the bearing is a self-alignment rolling bearing, and wherein the bearing width region is an interval of rolling members provided in the bearing.

9. The internal combustion engine startup torque transfer mechanism according to claim 8, wherein the bearing is a self-alignment ball bearing, and wherein the interval of rolling members is an interval of centers of rows of balls that are juxtaposed.

10. The internal combustion engine startup torque transfer mechanism according to claim 7, wherein, in the direction of the rotation axis, a center position of the mesh width region of the ring gear and the pinion is located in the bearing width region of the bearing.

11. The internal combustion engine startup torque transfer mechanism according to claim 7, wherein, in the direction of the rotation axis, a center position of the mesh width region of the ring gear and the pinion substantially coincides with a center position of the bearing width region of the bearing.

12. The internal combustion engine startup torque transfer mechanism according to claim 7, wherein the pinion and the ring gear are of a constant mesh type.

13. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein a ring-shape seal member is disposed between the ring gear and the crankshaft-side member, and wherein a seal lip of the ring-shape seal member is disposed in a mesh width region of the ring gear and the pinion in a direction of a rotation axis.

14. The internal combustion engine startup torque transfer mechanism according to claim 7, wherein, in the direction of the rotation axis, a center position of the mesh width region of the ring gear and the pinion is located at the seal lip of the ring-shape seal member.

15. The internal combustion engine startup torque transfer mechanism according to claim 7, wherein the pinion and the ring gear are of a constant mesh type.

16. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein a ring-shape seal member is disposed between the ring gear and a cylinder block-side member, and wherein a seal lip of the ring-shape seal member is disposed in a mesh width region of the ring gear and the pinion in a direction of a rotation axis.

17. The internal combustion engine startup torque transfer mechanism according to claim 16, wherein, in the direction of the rotation axis, a center position of the mesh width region of the ring gear and the pinion is located at the seal lip of the ring-shape seal member.

18. The internal combustion engine startup torque transfer mechanism according to claim 16, wherein the pinion and the ring gear are of a constant mesh type.

19. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein ring-shape seal members are disposed respectively between the ring gear and the crankshaft-side member, and between the ring gear and a cylinder block-side member, and wherein a seal lip of the ring-shape seal member is disposed in a mesh width region of the ring gear and the pinion in a direction of a rotation axis.

20. The internal combustion engine startup torque transfer mechanism according to claim 19, wherein, in the direction of the rotation axis, a center position of the mesh width region of the ring gear and the pinion is located at the seal lip of each ring-shape seal member.

21. The internal combustion engine startup torque transfer mechanism according to claim 19, wherein the pinion and the ring gear are of a constant mesh type.

22. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein a bearing width region of the bearing and a construction width region of the one-way clutch overlap with a mesh width region of the ring gear and the pinion in a direction of a rotation axis.

23. The internal combustion engine startup torque transfer mechanism according to claim 22, wherein the crankshaft-side member is a one-way clutch-purpose race support plate provided separately from a flywheel, and wherein the construction width region of the one-way clutch is a maximum width region between the one-way clutch-purpose race support plate and the ring gear.

24. The internal combustion engine startup torque transfer mechanism according to claim 22, wherein the crankshaft-side member is a flywheel, and wherein the construction width region of the one-way clutch is a maximum width region between the ring gear and a race member of the one-way clutch which is provided on the flywheel.

25. The internal combustion engine startup torque transfer mechanism according to claim 22, wherein the bearing is a self-alignment rolling bearing, and wherein the bearing width region is an interval of rolling members provided in the bearing.

26. The internal combustion engine startup torque transfer mechanism according to claim 25, wherein the bearing is a self-alignment ball bearing, and wherein the interval of rolling members is an interval of centers of rows of balls that are juxtaposed.

27. The internal combustion engine startup torque transfer mechanism according to claim 22, wherein, in the direction of the rotation axis, a center position of the mesh width region of the ring gear and the pinion is located in both the bearing width region of the bearing and the construction width region of the one-way clutch.

28. The internal combustion engine startup torque transfer mechanism according to claim 22, wherein, in the direction of the rotation axis, a center position of the mesh width region of the ring gear and the pinion substantially coincides with both a center position of the bearing width region of the bearing and a center position of the construction width region of the one-way clutch.

29. The internal combustion engine startup torque transfer mechanism according to claim 22, wherein the pinion and the ring gear are of a constant mesh type.

30. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein a ring-shape seal member is disposed between the ring gear and the crankshaft-side member, and wherein a construction width region of the one-way clutch overlaps with a mesh width region of the ring gear and the pinion in a direction of a rotation axis, and wherein a seal lip of the ring-shape seal member is disposed in the mesh width region in the direction of the rotation axis.

31. The internal combustion engine startup torque transfer mechanism according to claim 30, wherein the crankshaft-side member is a one-way clutch-purpose race support plate provided separately from a flywheel, and wherein the construction width region of the one-way clutch is a maximum width region between the one-way clutch-purpose race support plate and the ring gear.

32. The internal combustion engine startup torque transfer mechanism according to claim 30, wherein the crankshaft-side member is a flywheel, and wherein the construction width region of the one-way clutch is a maximum width region between the ring gear and a race member of the one-way clutch which is provided on the flywheel.

33. The internal combustion engine startup torque transfer mechanism according to claim 30, wherein, in the direction of the rotation axis, a center position of the mesh width region of the ring gear and the pinion, and a position of the seal lip of the ring-shape seal member are located in the construction width region of the one-way clutch.

34. The internal combustion engine startup torque transfer mechanism according to claim 30, wherein, in the direction of the rotation axis, a center position of the mesh width region of the ring gear and the pinion, a position of the seal lip of the ring-shape seal member, and a center position of the construction width region of the one-way clutch substantially coincide.

35. The internal combustion engine startup torque transfer mechanism according to claim 30, wherein the pinion and the ring gear are of a constant mesh type.

36. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein a ring-shape seal member is disposed between the ring gear and a cylinder block-side member, and wherein a construction width region of the one-way clutch overlaps with a mesh width region of the ring gear and the pinion in a direction of a rotation axis, and wherein a seal lip of the ring-shape seal member is disposed in the mesh width region in the direction of the rotation axis.

37. The internal combustion engine startup torque transfer mechanism according to claim 36, wherein the crankshaft-side member is a one-way clutch-purpose race support plate provided separately from a flywheel, and wherein the construction width region of the one-way clutch is a maximum width region between the one-way clutch-purpose race support plate and the ring gear.

38. The internal combustion engine startup torque transfer mechanism according to claim 36, wherein the crankshaft-side member is a flywheel, and wherein the construction width region of the one-way clutch is a maximum width region between the ring gear and a race member of the one-way clutch which is provided on the flywheel.

39. The internal combustion engine startup torque transfer mechanism according to claim 36, wherein, in the direction of the rotation axis, a center position of the mesh width region of the ring gear and the pinion, and a position of the seal lip of the ring-shape seal member are located in the construction width region of the one-way clutch.

40. The internal combustion engine startup torque transfer mechanism according to claim 36, wherein, in the direction of the rotation axis, a center position of the mesh width region of the ring gear and the pinion, a position of the seal lip of the ring-shape seal member, and a center position of the construction width region of the one-way clutch substantially coincide.

41. The internal combustion engine startup torque transfer mechanism according to claim 36, wherein the pinion and the ring gear are of a constant mesh type.

42. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein ring-shape seal members are disposed respectively between the ring gear and the crankshaft-side member, and between the ring gear and a cylinder block-side member, and wherein a construction width region of the one-way clutch overlaps with a mesh width region of the ring gear and the pinion in a direction of a rotation axis, and wherein a seal lip of each ring-shape seal member is disposed in the mesh width region in the direction of the rotation axis.

43. The internal combustion engine startup torque transfer mechanism according to claim 42, wherein the crankshaft-side member is a one-way clutch-purpose race support plate provided separately from a flywheel, and wherein the construction width region of the one-way clutch is a maximum width region between the one-way clutch-purpose race support plate and the ring gear.

44. The internal combustion engine startup torque transfer mechanism according to claim 42, wherein the crankshaft-side member is a flywheel, and wherein the construction width region of the one-way clutch is a maximum width region between the ring gear and a race member of the one-way clutch which is provided on the flywheel.

45. The internal combustion engine startup torque transfer mechanism according to claim 42, wherein, in the direction of the rotation axis, a center position of the mesh width region of the ring gear and the pinion, and a position of the seal lip of each ring-shape seal member are located in the construction width region of the one-way clutch.

46. The internal combustion engine startup torque transfer mechanism according to claim 42, wherein, in the direction of the rotation axis, a center position of the mesh width region of the ring gear and the pinion, a position of the seal lip of each ring-shape seal member, and a center position of the construction width region of the one-way clutch substantially coincide.

47. The internal combustion engine startup torque transfer mechanism according to claim 42, wherein the pinion and the ring gear are of a constant mesh type.

48. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein a ring-shape seal member is disposed between the ring gear and the crankshaft-side member, and wherein a bearing width region of the bearing overlaps with a mesh width region of the ring gear and the pinion in a direction of a rotation axis, and wherein a seal lip of the ring-shape seal member is disposed in the mesh width region in the direction of the rotation axis.

49. The internal combustion engine startup torque transfer mechanism according to claim 48, wherein the bearing is a self-alignment rolling bearing, and wherein the bearing width region is an interval of rolling members provided in the bearing.

50. The internal combustion engine startup torque transfer mechanism according to claim 49, wherein the bearing is a self-alignment ball bearing, and wherein the interval of rolling members is an interval of centers of rows of balls that are juxtaposed.

51. The internal combustion engine startup torque transfer mechanism according to claim 48, wherein, in the direction of the rotation axis, a center position of the mesh width region of the ring gear and the pinion, and a position of the seal lip of the ring-shape seal member are located in the bearing width region of the bearing.

52. The internal combustion engine startup torque transfer mechanism according to claim 48, wherein, in the direction of the rotation axis, a center position of the mesh width region of the ring gear and the pinion, a position of the seal lip of the ring-shape seal member, and a center position of the bearing width region of the bearing substantially coincide.

53. The internal combustion engine startup torque transfer mechanism according to claim 48, wherein the pinion and the ring gear are of a constant mesh type.

54. An internal combustion engine startup torque transfer mechanism comprising.
a pinion that is rotated by a starter motor;
a ring gear that meshes with the pinion and that transfers a torque of the pinion to a
crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein a ring-shape seal member is disposed between the ring gear and a cylinder block-side member, and wherein a bearing width region of the bearing overlaps with a mesh width region of the ring gear and the pinion in a direction of a rotation axis, and wherein a seal lip of the ring-shape seal member is disposed in the mesh width region in the direction of the rotation axis.

55. The internal combustion engine startup torque transfer mechanism according to claim 54, wherein the bearing is a self-alignment rolling bearing, and wherein the bearing width region is an interval of rolling members provided in the bearing.

56. The internal combustion engine startup torque transfer mechanism according to claim 54, wherein the bearing is a self-alignment ball bearing, and wherein the interval of rolling members is an interval of centers of rows of balls that are juxtaposed.

57. The internal combustion engine startup torque transfer mechanism according to claim 54, wherein, in the direction of the rotation axis, a center position of the mesh width region of the ring gear and the pinion, and a position of the seal lip of the ring-shape seal member are located in the bearing width region of the bearing.

58. The internal combustion engine startup torque transfer mechanism according to claim 54, wherein, in the direction of the rotation axis, a center position of the mesh width region of the ring gear and the pinion, a position of the seal lip of the ring-shape seal member, and a center position of the bearing width region of the bearing substantially coincide.

59. The internal combustion engine startup torque transfer mechanism according to claim 54, wherein the pinion and the ring gear are of a constant mesh type.

60. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein ring-shape seal members are disposed respectively between the ring gear and the crankshaft-side member, and between the ring gear and a cylinder block-side member, and wherein a bearing width region of the bearing overlaps with a mesh width region of the ring gear and the pinion in a direction of a rotation axis, and wherein a seal lip of each ring-shape seal member is disposed in the mesh width region in the direction of the rotation axis.

61. The internal combustion engine startup torque transfer mechanism according to claim 60, wherein the bearing is a self-alignment rolling bearing, and wherein the bearing width region is an interval of rolling members provided in the bearing.

62. The internal combustion engine startup torque transfer mechanism according to claim 60, wherein the bearing is a self-alignment ball bearing, and wherein the interval of rolling members is an interval of centers of rows of balls that are juxtaposed.

63. The internal combustion engine startup torque transfer mechanism according to claim 60, wherein, in the direction of the rotation axis, a center position of the mesh width region of the ring gear and the pinion, and a position of the seal lip of each ring-shape seal member are located in the bearing width region of the bearing.

64. The internal combustion engine startup torque transfer mechanism according to claim 60, wherein, in the direction of the rotation axis, a center position of the mesh width region of the ring gear and the pinion, a position of the seal lip of each ring-shape seal member, and a center position of the bearing width region of the bearing substantially coincide.

65. The internal combustion engine startup torque transfer mechanism according to claim 60, wherein the pinion and the ring gear are of a constant mesh type.

66. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein a ring-shape seal member is disposed between the ring gear and the crankshaft-side member, and wherein a bearing width region of the bearing, and a construction width region of the one-way clutch overlap with a mesh width region of the ring gear and the pinion in a direction of a rotation axis, and wherein a seal lip of the ring-shape seal member is disposed in the mesh width region in the direction of the rotation axis.

67. The internal combustion engine startup torque transfer mechanism according to claim 66, wherein the bearing is a self-alignment rolling bearing, and wherein the bearing width region is an interval of rolling members provided in the bearing.

68. The internal combustion engine startup torque transfer mechanism according to claim 67, wherein the bearing is a self-alignment ball bearing, and wherein the interval of rolling members is an interval of centers of rows of balls that are juxtaposed.

69. The internal combustion engine startup torque transfer mechanism according to claim 66, wherein the crankshaft-side member is a one-way clutch-purpose race support plate provided separately from a flywheel, and wherein the construction width region of the one-way clutch is a maximum width region between the one-way clutch-purpose race support plate and the ring gear.

70. The internal combustion engine startup torque transfer mechanism according to claim 66, wherein the crankshaft-side member is a flywheel, and wherein the construction width region of the one-way clutch is a maximum width region between the ring gear and a race member of the one-way clutch which is provided on the flywheel.

71. The internal combustion engine startup torque transfer mechanism according to claim 66, wherein, in the direction of the rotation axis, a center position of the mesh width region of the ring gear and the pinion, and a position of the seal lip of the ring-shape seal member are located in both the construction width region of the one-way clutch and the bearing width region of the bearing.

72. The internal combustion engine startup torque transfer mechanism according to claim 66, wherein, in the direction of the rotation axis, a center position of the mesh width region of the ring gear and the pinion, a position of the seal lip of the ring-shape seal member, a center position of the construction width region of the one-way clutch, and a center position of the bearing width region of the bearing substantially coincide.

73. The internal combustion engine startup torque transfer mechanism according to claim 66, wherein the pinion and the ring gear are of a constant mesh type.

74. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein a ring-shape seal member is disposed between the ring gear and a cylinder block-side member, and wherein a bearing width region of the bearing, and a construction width region of the one-way clutch overlap with a mesh width region of the ring gear and the pinion in a direction of a rotation axis, and wherein a seal lip of the ring-shape seal member is disposed in the mesh width region in the direction of the rotation axis.

75. The internal combustion engine startup torque transfer mechanism according to claim 74, wherein the bearing is a self-alignment rolling bearing, and wherein the bearing width region is an interval of rolling members provided in the bearing.

76. The internal combustion engine startup torque transfer mechanism according to claim 74, wherein the bearing is a self-alignment ball bearing, and wherein the interval of rolling members is an interval of centers of rows of balls that are juxtaposed.

77. The internal combustion engine startup torque transfer mechanism according to claim 74, wherein the crankshaft-side member is a one-way clutch-purpose race support plate provided separately from a flywheel, and wherein the construction width region of the one-way clutch is a maximum width region between the one-way clutch-purpose race support plate and the ring gear.

78. The internal combustion engine startup torque transfer mechanism according to claim 74, wherein the crankshaft-side member is a flywheel, and wherein the construction width region of the one-way clutch is a maximum width region between the ring gear and a race member of the one-way clutch which is provided on the flywheel.

79. The internal combustion engine startup torque transfer mechanism according to claim 74, wherein, in the direction of the rotation axis, a center position of the mesh width region of the ring gear and the pinion, and a position of the seal lip of the ring-shape seal member are located in both the construction width region of the one-way clutch and the bearing width region of the bearing.

80. The internal combustion engine startup torque transfer mechanism according to claim 74, wherein, in the direction of the rotation axis, a center position of the mesh width region of the ring gear and the pinion, a position of the seal lip of the ring-shape seal member, a center position of the construction width region of the one-way clutch, and a center position of the bearing width region of the bearing substantially coincide.

81. The internal combustion engine startup torque transfer mechanism according to claim 74, wherein the pinion and the ring gear are of a constant mesh type.

82. An internal combustion engine startup torque transfer mechanism comprising:
a pinion that is rotated by a starter motor;
a ring gear that meshes with the pinion and that transfers a torque of the pinion to a crankshaft of an internal combustion engine; and
a one-way clutch that is provided between the ring gear and a crankshaft-side member, and that transfers a torque in one direction provided by the starter motor from the ring gear to the crankshaft, and that prevents a torque in a reverse direction from being transferred,
wherein the ring gear is freely rotatably mounted to a crankshaft side via a bearing, and wherein ring-shape seal members are disposed respectively between the ring gear and the crankshaft-side member, and between the ring gear and a cylinder block-side member, and wherein a bearing width region of the bearing, and a construction width region of the one-way clutch overlap with a mesh width region of the ring gear and the pinion in a direction of a rotation axis, and wherein a seal lip of each ring-shape seal member is disposed in the mesh width region in the direction of the rotation axis.

83. The internal combustion engine startup torque transfer mechanism according to claim 82, wherein the bearing is a self-alignment rolling bearing, and wherein the bearing width region is an interval of rolling members provided in the bearing.

84. The internal combustion engine startup torque transfer mechanism according to claim 82, wherein the bearing is a self-alignment ball bearing, and wherein the interval of rolling members is an interval of centers of rows of balls that are juxtaposed.

85. The internal combustion engine startup torque transfer mechanism according to claim 82, wherein the crankshaft-side member is a one-way clutch-purpose race support plate provided separately from a flywheel, and wherein the construction width region of the one-way clutch is a maximum width region between the one-way clutch-purpose race support plate and the ring gear.

86. The internal combustion engine startup torque transfer mechanism according to claim 82, wherein the crankshaft-side member is a flywheel, and wherein the construction width region of the one-way clutch is a maximum width region between the ring gear and a race member of the one-way clutch which is provided on the flywheel.

87. The internal combustion engine startup torque transfer mechanism according to claim 82, wherein, in the direction of the rotation axis, a center position of the mesh width region of the ring gear and the pinion, and a position of the seat lip of each ring-shape seal member are located in both the construction width region of the one-way clutch and the bearing width region of the bearing.

88. The internal combustion engine startup torque transfer mechanism according to claim 82, wherein, in the direction of the rotation axis, a center position of the mesh width region of the ring gear and the pinion, a position of the seal lip of each ring-shape seal member, a center position of the construction width region of the one-way clutch, and a center position of the bearing width region of the bearing substantially coincide.

89. The internal combustion engine startup torque transfer mechanism according to claim 82, wherein the pinion and the ring gear are of a constant mesh type.
